(19) United States
(12) Patent Application Publication
(10) Pub. No.: US 2025/0156265 A1
(43) Pub. Date: May 15, 2025

(54) INFORMATION PROCESSING SYSTEM, INFORMATION PROCESSING METHOD, AND DISPLAY METHOD

(71) Applicant: Panasonic Intellectual Property Management Co., Ltd., Osaka (JP)

(72) Inventors: Tatsuaki AMEMURA, Tokyo (JP); Yuya ADACHI, Kanagawa (JP); Tetsushi OHORI, Tokyo (JP)

(21) Appl. No.: 18/938,699

(22) Filed: Nov. 6, 2024

(30) Foreign Application Priority Data
Nov. 15, 2023 (JP) 2023-194630

(51) Int. Cl. G06F 11/07

(52) U.S. Cl. CPC G06F 11/0793; G06F 11/0769

(57) ABSTRACT

An information processing system is connected to a production management system and a first computer via the Internet, and includes: an acquirer that acquires information related to an error in the production management system; and a controller that displays, on a display of the first computer, a procedure including a plurality of steps to be taken after the error has occurred until a measure for eliminating the error is performed and a message corresponding to each of one or more steps from a first step up to a current step among the plurality of steps.

### CROSS REFERENCE TO RELATED APPLICATION

The present application is based on and claims priority of Japanese Patent Application No. 2023-194630 filed on Nov. 15, 2023. The entire disclosure of the above-identified application, including the specification, drawings and claims is incorporated herein by reference in its entirety.

### FIELD

The present disclosure relates to an information processing system, an information processing method, and a display method.

### BACKGROUND

Patent Literature 1 discloses that the progress of a plurality of tasks in a distribution server is displayed.

### CITATION LIST

### Patent Literature

PTL 1: Japanese Unexamined Patent Application Publication No. 2016-177567

### SUMMARY

### Technical Problem

However, for example, when an error occurs to prevent a task from proceeding fully automatically, it may be difficult for a user to inquire about progress. In particular, in the technical field of mounting devices, it is difficult to eliminate errors fully automatically, and thus human intervention is often required to eliminate errors.

Hence, the present disclosure provides an information processing system and the like in which a user can easily inquire about progress.

### Solution to Problem

An information processing system according to an aspect of the present disclosure is an information processing system connected to a production management system and a first computer via Internet, and includes: an acquirer that acquires information related to an error in the production management system; and a controller that displays, on a display of the first computer: a procedure including a plurality of steps to be taken after the error has occurred until a measure for eliminating the error is performed; and a message corresponding to each of one or more steps from a first step up to a current step among the plurality of steps.

An information processing method according to an aspect of the present disclosure is an information processing method that is performed by an information processing system connected to a production management system and a first computer via Internet, and includes: acquiring information related to an error in the production management system; and displaying, on a display of the first computer, a procedure including a plurality of steps to be taken after the error has occurred until a measure for eliminating the error is performed and a message corresponding to each of one or more steps up to a current step among the plurality of steps.

A display method according to an aspect of the present disclosure is a display method to be performed by a computer connected to a production management system and an information processing system via Internet, and includes: acquiring, by the computer, display information to be displayed on a display of the computer, from the information processing system; and displaying, on the display of the computer, an on-screen display based on the display information, and the on-screen display includes: a procedure including a plurality of steps to be taken after an error has occurred until a measure for eliminating the error is performed; and a message corresponding to each of one or more steps up to a current step among the plurality of steps.

These general or specific aspects may be realized by a device, an integrated circuit, a computer program, or a computer-readable recording medium such as a CD-ROM, or may be realized by any combination of a device, a system, a method, an integrated circuit, a computer program, and a recording medium. The recording medium may be a non-transitory recording medium.

### Advantageous Effects

In the information processing system of the present disclosure, a user can easily inquire about progress.

Further advantages and effects of the aspect of the present disclosure will become apparent from the specification and drawings. Such advantages and/or effects are provided by features described in some embodiments, the specification, and the drawings, but not all of them need to be provided in order to obtain one or more same features.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram showing an information processing system according to an embodiment.

FIG. 2 is a diagram showing a first example of a user interface (UI) displayed on a display.

FIG. 3 is a diagram showing a second example of the UI displayed on the display.

FIG. 4 is a diagram showing a third example of the UI displayed on the display.

FIG. 5 is a diagram showing a fourth example of the UI displayed on the display.

FIG. 6 is a diagram showing a fifth example of the UI displayed on the display.

FIG. 7 is a diagram showing a sixth example of the UI displayed on the display.

FIG. 8 is a diagram showing a seventh example of the UI displayed on the display.

FIG. 9 is a diagram showing an eighth example of the UI displayed on the display.

FIG. 10 is a diagram showing a ninth example of the UI displayed on the display.

FIG. 11 is a flowchart showing an example of inquiry measure processing for eliminating an error performed by a server.

FIG. 12 is a sequence diagram showing an example of the inquiry measure processing for eliminating an error in the information processing system.

### DESCRIPTION OF EMBODIMENT

An information processing system according to a first aspect of the present disclosure is an information processing system connected to a production management system and a first computer via Internet, and includes: an acquirer that acquires information related to an error in the production management system; and a controller that displays, on a display of the first computer: a procedure including a plurality of steps to be taken after the error has occurred until a measure for eliminating the error is performed; and a message corresponding to each of one or more steps from a first step up to a current step among the plurality of steps.

In this way, the procedure including the plurality of steps to be taken after the error has occurred until the measure for eliminating the error is performed and the message corresponding to each of the steps are displayed, and thus it is possible to present, to the user, the progress for eliminating the error and the message corresponding to the progress. Hence, the user can easily recognize the message corresponding to the current step in the progress, and thereby can easily inquire about the progress.

An information processing system according to a second aspect of the present disclosure is the information processing system according to the first aspect, and the controller displays, on the display, the message together with step information indicating a step corresponding to the message among the plurality of steps.

Hence, the user can easily recognize the message corresponding to each of the steps in the progress.

An information processing system according to a third aspect of the present disclosure is the information processing system according to the first or second aspect, the message is generated by the information processing system, and the controller displays, on the display, the message together with generator information indicating a generator of the message.

Hence, the user can easily recognize the generator of the message.

An information processing system according to a fourth aspect of the present disclosure is the information processing system according to any one of the first to third aspects, the acquirer further acquires a log related to at least one of an operation or a state of the production management system, and the controller: determines whether the controller is capable of determining, based on the log, the measure for eliminating the error; generates a first message including a detail of the measure when determining that the controller is capable of determining the measure; and displays, on the display, the first message together with the generator information indicating the information processing system.

Hence, the user can easily recognize that the first message has been automatically generated by the information processing system.

An information processing system according to a fifth aspect of the present disclosure is the information processing system according to any one of the first to third aspects, and the controller: determines whether the controller is capable of determining, based on the error, the measure for eliminating the error; generates a second message including a detail of the measure when determining that the controller is capable of determining, based on the error, the measure; and displays, on the display, the second message together with the generator information indicating the information processing system.

Hence, the user can easily recognize that the first message has been automatically generated by the information processing system.

An information processing system according to a sixth aspect of the present disclosure is the information processing system according to the fifth aspect, the acquirer further acquires a log related to at least one of an operation or a state of the production management system when the controller determines that the controller is not capable of determining the measure for eliminating the error, and the controller: determines whether the controller is capable of determining, based on the log, the measure for eliminating the error; generates a first message including a detail of the measure when determining that the controller is capable of determining, based on the log, the measure; and displays, on the display, the first message together with the generator information indicating the information processing system.

Hence, the user can easily recognize that the first message has been automatically generated by the information processing system.

An information processing system according to a seventh aspect of the present disclosure is the information processing system according to any one of the fourth to sixth aspects, and the acquirer acquires the log from a database included in the information processing system.

Hence, the information processing system can perform processing using the log previously acquired from the production management system, and thus it is possible to reduce the time until the processing is started.

An information processing system according to an eighth aspect of the present disclosure is the information processing system according to any one of the fourth to seventh aspects, the controller determines whether a database included in the information processing system includes the log, and when the controller determines that the database does not include the log, the acquirer acquires the log from the production management system via the Internet.

Hence, when the log is acquired from the database, the information processing system can perform processing using the log previously acquired from the production management system, and thus it is possible to reduce the time until the processing is started. On the other hand, when the log cannot be acquired from the database, the information processing system can reduce a storage capacity for storing the log.

An information processing system according to a ninth aspect of the present disclosure is the information processing system according to any one of the fourth to eighth aspects, and the acquirer acquires the log from the production management system via the Internet.

Hence, when the log cannot be acquired from the database, the information processing system can reduce a storage capacity for storing the log.

An information processing system according to a tenth aspect of the present disclosure is the information processing system according to any one of the fourth to ninth aspects, and the controller: transmits, via the Internet, a request for input of a message related to the measure to a second computer when determining that the controller is not capable of determining the measure; and displays, on the display, a third message transmitted from the second computer in response to the request together with the generator information indicating the second computer.

Hence, the user can easily recognize that the second message has been input by the operator of the second computer.

An information processing system according to an eleventh aspect of the present disclosure is the information processing system according to any one of the first to tenth aspects, and when one step among the plurality of steps has been completed, the controller displays, on the display, together with a step subsequent to the one step, a message corresponding to the step subsequent to the one step.

Hence, when the one step has been completed, the user can recognize the message for the subsequent step.

An information processing system according to a twelfth aspect of the present disclosure is the information processing system according to the eleventh aspect, and when one step among the plurality of steps has been completed, the controller displays, on the display, completion information indicating that the one step has been completed.

Hence, the user can recognize that the one step has been completed.

An information processing system according to a thirteenth aspect of the present disclosure is the information processing system according to the twelfth aspect, the plurality of steps include acquiring a log related to at least one of an operation or a state of the production management system, and when the acquiring of the log has been completed, the controller displays, on the display, completion of a transition to a step subsequent to the acquiring of the log.

Hence, the user can recognize the completion of the transition to the step subsequent to the acquiring of the log.

An information processing system according to a fourteenth aspect of the present disclosure is the information processing system according to any one of the first to thirteenth aspects, and the production management system includes: a mounting line that includes a mounting device and a printing device; and a production support device that supports production on the mounting line.

An information processing method according to a fifteenth aspect of the present disclosure is an information processing method to be performed by an information processing system connected to a production management system and a first computer via Internet, and the information processing method includes: acquiring information related to an error in the production management system; and displaying, on a display of the first computer, a procedure including a plurality of steps to be taken after the error has occurred until a measure for eliminating the error is performed and a message corresponding to each of one or more steps up to a current step among the plurality of steps.

In this way, the procedure including the plurality of steps to be taken after the error has occurred until the measure for eliminating the error is performed and the message corresponding to each of the steps are displayed, and thus it is possible to present, to the user, the progress for eliminating the error and the message corresponding to the progress. Hence, the user can easily recognize the message corresponding to the current step in the progress, and thereby can easily inquire about the progress.

A display method according to a sixteenth aspect of the present disclosure is a display method to be performed by a computer connected to a production management system and an information processing system via Internet, the display method includes: acquiring, by the computer, display information to be displayed on a display of the computer, from the information processing system; and displaying, on the display of the computer, an on-screen display based on the display information, and the on-screen display includes: a procedure including a plurality of steps to be taken after an error has occurred until a measure for eliminating the error is performed; and a message corresponding to each of one or more steps up to a current step among the plurality of steps.

In this way, the procedure including the plurality of steps to be taken after the error has occurred until the measure for eliminating the error is performed and the message corresponding to each of the steps are displayed, and thus it is possible to present, to the user, the progress for eliminating the error and the message corresponding to the progress. Hence, the user can easily recognize the message corresponding to the current step in the progress, and thereby can easily inquire about the progress.

### Embodiment

### 1. Configuration

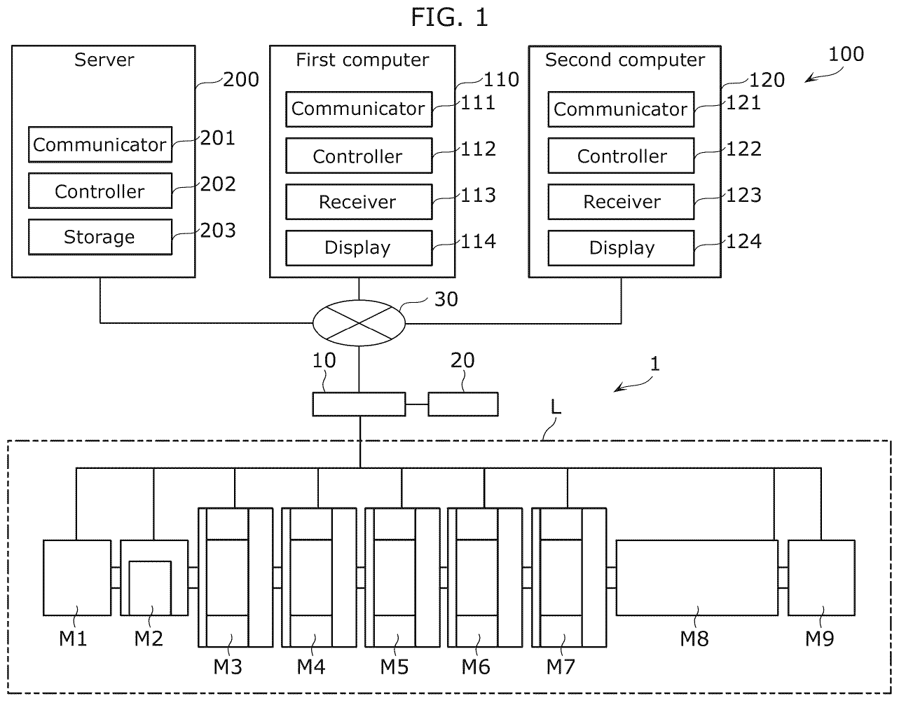

FIG. 1 is a schematic diagram showing a system according to an embodiment. System 100 will be described with reference to FIG. 1.

As shown in FIG. 1, system 100 includes production management system 1, and first computer 110, second computer 120, and server 200 which are connected to production management system 1 via network 30.

Production management system 1 is a production management system for producing products. Examples of the product include a mounting substrate on which electronic components and the like are mounted, a semiconductor, food, and the like. Production management system 1 includes production line L, production management device 10, and line management device 20.

Production management device 10 generates and outputs production data for producing the mounting substrate. Production management device 10 may communicate with production line L via wireless or wired connection. The wireless connection may be Wi-Fi (registered trademark), Bluetooth (registered trademark), ZigBee (registered trademark), or a specific low-power wireless connection. Production management device 10 is an example of a support device which manages a production preparation operation of at least one of a plurality of production devices M1 to M9 included in production line L to support the at least one thereof.

Production line L is a production line for producing the products. For example, when the product is the mounting substrate, production line L is a component mounting line for mounting electronic components on the substrate. Production line L includes production devices M1 to M9.

Each of production devices M1 to M9 is a production device for producing the products. The products are produced through a plurality of steps performed by production devices M1 to M9. For example, when the product is the mounting substrate, production device M1 is a loader which supplies the substrate to production line L, and production device M2 is a solder printing device which prints solder on the substrate. For example, when the product is the mounting substrate, each of production devices M3 to M7 is a component mounting device which mounts an electronic component on the substrate, production device M8 is a reflow furnace which melts the solder printed on the substrate, and production device M9 is a loader which discharges the mounting substrate from production line L. Production line L does not need to include all production devices M1 to M9, and may include at least one thereof. Production line L may include an inspection device that inspects the substrate on which the solder is printed or the substrate on which the components are mounted.

Line management device 20 is a device which manages each of production devices M1 to M9 included in one production line L. Line management device 20 acquires, from production management device 10, the production data generated by production management device 10, and causes operation devices included in production line L to perform production of the mounting substrate based on the production data. Line management device 20 is an example of a support device which manages at least one of production devices M1 to M9 included in production line L to support the at least one thereof.

For example, production line L may include one production device instated of a plurality of production devices. For example, production management system 1 may include a plurality of production lines L instated of one production line. When production management system 1 includes a plurality of production lines, production management system 1 may include a plurality of line management devices 20 for managing the production lines.

Production management device 10, line management device 20, and production devices M1 to M9 are examples of a plurality of devices for production used in the production of the mounting substrate.

First computer 110 is a computer which is used by the user of production management system 1. In other words, first computer 110 is a computer which is owned by the user of production management system 1. First computer 110 includes communicator 111, controller 112, receiver 113, and display 114.

Communicator 111 exchanges, via network 30, information with second computer 120, server 200, or production management system 1. Communicator 111 receives display information from server 200. Communicator 111 may transmit, to server 200, information (inquiry information) input by the user.

When communicator 111 receives the display information, controller 112 displays a user interface (UI) on display 114 based on the received display information. The UI may be a graphic user interface. Specific examples of the UI to be displayed will be described later.

Receiver 113 is an input interface (IF) which receives an input from the user. Receiver 113 receives an input to the UI displayed on display 114. Specific examples of the input to be received will be described later.

Display 114 is a display which displays an image or the UI. Display 114 displays the image or the UI which is generated by controller 112.

Second computer 120 is used by a manager who manages service provided by server 200. In other words, second computer 120 is a computer which is owned by the manager. The manager is, for example, an operator of customer service. The manager responds with an appropriate reply to an inquiry made by the user. Second computer 120 includes communicator 121, controller 122, receiver 123, and display 124.

Communicator 121 exchanges, via network 30, information with first computer 110, server 200, or production management system 1. Communicator 121 receives display information from server 200. Communicator 121 may transmit, to server 200, information (reply information) input by the manager.

When communicator 121 receives the display information, controller 122 displays a UI on display 124 based on the received display information. Specific examples of the UI to be displayed will be described later.

Receiver 123 is an input interface (IF) which receives an input from the manager. Receiver 123 receives an input to the UI displayed on display 124. Specific examples of the input to be received will be described later.

Display 124 is a display which displays an image or the UI. Display 124 displays the image or the UI which is generated by controller 122.

Server 200 is an information processing device which acquires error information indicating an error that occurs in production management system 1, and performs, based on the error information, processing for eliminating the error indicated by the error information. Server 200 is an example of an information processing system. Server 200 includes communicator 201, controller 202, and storage 203.

Communicator 201 exchanges, via network 30, information with first computer 110, second computer 120, and production management system 1. Communicator 201 acquires the error information related to the error in production management system 1 from production management system 1. Communicator 201 may acquire the error information from production management device 10, may acquire the error information from line management device 20, or may acquire the error information from production line L. Communicator 201 may acquire a log related to at least one of the operation or the state of production management system 1. Communicator 201 may acquire the log periodically. For example, communicator 201 may acquire a log which is newly generated in production management system 1 after the previous acquisition. Communicator 201 may acquire one log or a plurality of logs. In the following description, simple log acquisition is assumed to be performed. Communicator 201 is an example of an acquirer.

Controller 202 generates the display information for displaying the UI on display 114 of first computer 110, and transmits the generated display information to first computer 110 via communicator 201. In this way, controller 202 displays the UI based on the display information on display 114 of first computer 110. The display information is information for displaying, on display 114, the UI which includes a procedure including a plurality of steps to be taken after an error has occurred until a measure for eliminating the error is performed and a message corresponding to each of one or more steps from a first step up to the current step among the plurality of steps. Controller 202 displays the message on display 114 together with step information indicating the step corresponding to the message among the plurality of steps. The message is generated by at least one of server 200, first computer 110, or second computer 120.

In other words, the message may be generated by server 200, may be generated by first computer 110, or may be generated by second computer 120. The message which is generated by server 200 is automatically generated based on a predetermined algorithm. The message which is generated by first computer 110 is generated based on an input made by the user of first computer 110. The message which is generated by second computer 120 is generated based on an input made by the user of second computer 120. In other words, the message which is generated by server 200 is a message which is automatically generated by the computer, and the message which is generated by first computer 110 and the message which is generated by second computer 120 are messages which are generated based on inputs made by humans.

Controller 202 may display the message on the UI together with generator information indicating the generator of the message. The generator information may be the name of the generator, or may be an icon indicating the generator.

Here, that the message is displayed together with the step information or the generator information means that the step information or the generator information is displayed in the vicinity of the message. For example, that the message is displayed together with the step information or the generator information may mean that the step information or the generator information is displayed closer to the message than to another message, or may mean that the step information or the generator information is displayed inside a frame surrounding the message. This frame is a frame which surrounds only one message, and another message is not included in the region of the frame.

Controller 202 may determine whether controller 202 is capable of automatically determining the measure for eliminating the error in production management system 1 without human intervention. Controller 202 may determine whether controller 202 is capable of determining, based on the error indicated by the acquired error information, the measure for eliminating the error, or may determine whether controller 202 is capable of determining, based on the log of production management system 1, the measure for eliminating the error. When controller 202 determines that controller 202 is not capable of determining the measure for eliminating the error in the above determination based on the error, controller 202 may perform the above determination based on the log. In this case, in order to perform the determination based on the log, controller 202 acquires the log from the database in storage 203 or production management system 1. When controller 202 acquires the log, controller 202 may determine whether the database in storage 203 includes the log, and when controller 202 determines that the database does not include the log, controller 202 may acquire the log from production management system 1 via network 30.

When controller 202 determines whether controller 202 is capable of determining the measure for eliminating the error based on the error indicated by the acquired error information, for example, controller 202 determines whether a table includes the measure for eliminating the error which is associated with the error. The table is information which is previously stored in storage 203, and in which each type of error is associated with a measure for eliminating the error. When the measure for eliminating the error which corresponds to the error indicated by the error information is included in the table, controller 202 determines that controller 202 is capable of determining the measure for eliminating the error based on the error described above. Then, controller 202 determines, as the measure for eliminating the error, the measure for eliminating the error which is associated with the error in the table. When the measure for eliminating the error which corresponds to the error indicated by the error information is not included in the table, controller 202 determines that controller 202 is not capable of determining the measure for eliminating the error based on the error described above.

When controller 202 determines whether controller 202 is capable of determining, based on the log, the measure for eliminating the error, for example, controller 202 determines whether the log includes a history indicating that the error indicated by the error information has been automatically eliminated. In other words, when controller 202 determines that the log includes the history indicating that the error indicated by the error information has been automatically eliminated, controller 202 determines that controller 202 is capable of determining the measure for eliminating the error. Then, when the log includes the history indicating that the error has been automatically eliminated, controller 202 determines the measure for eliminating the error based on the log including the history indicating that the error has been automatically eliminated. For example, the log including the history indicating that the error has been automatically eliminated may be change of a predetermined parameter, an update of software, or the like. When controller 202 determines that the log does not include the history indicating that the error indicated by the error information has been automatically eliminated, controller 202 determines that controller 202 is not capable of determining the measure for eliminating the error.

When controller 202 determines that controller 202 is capable of determining the measure for eliminating the error, controller 202 generates a message which includes a detail for eliminating the error. Then, controller 202 displays the generated message on display 114 of first computer 110 together with the generator information indicating server 200. The message which includes the detail of the measure determined based on the error is an example of a second message. The message which includes the detail of the measure determined based on the log is an example of a first message. The generator information indicating server 200 may be an icon indicating server 200 or may be information indicating that the message has been automatically generated. The icon indicating server 200 may include an illustration or a photograph of a computer or may include an illustration or a photograph of a robot.

When controller 202 determines that controller 202 is not capable of determining the measure for eliminating the error, controller 202 transmits a request for input of a message related to the measure to second computer 120 via network 30. When communicator 201 receives, from second computer 120, information indicating the message transmitted from second computer 120 in response to the request, controller 202 displays, on display 114 of first computer 110, the message transmitted from second computer 120 in response to the request together with the generator information indicating second computer 120. The message transmitted from second computer 120 is an example of a third message. The generator information indicating second computer 120 may be the name of the manager or an icon indicating the manager. The icon indicating the manager may be an illustration or a photograph including the face of the manager.

When one of a plurality of steps has been completed, controller 202 may display, together with the step subsequent to the one step described above, a message corresponding to the subsequent step on display 114 of first computer 110. When one of a plurality of steps has been completed, controller 202 may display, on display 114 of first computer 110, completion information indicating that the one step has been completed. The steps include acquiring the log of production management system 1. When the acquiring of the log has been completed, controller 202 may display, on display 114 of first computer 110, the completion of a transition to the step subsequent to the acquiring of the log.

### 2. Display Example

The UI displayed on display 114 will then be described.

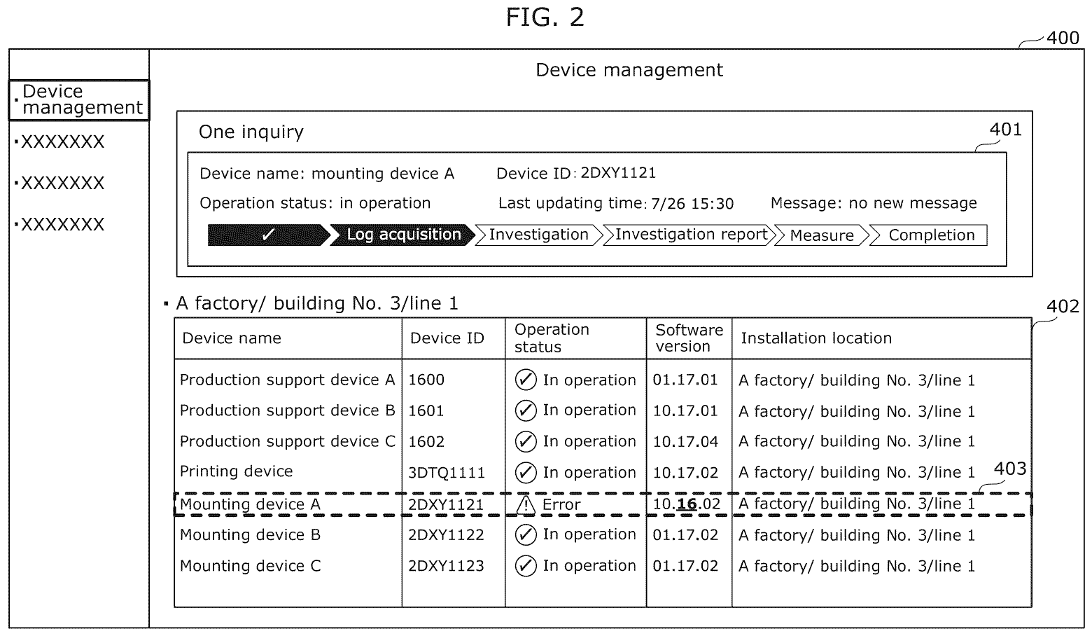

FIGS. 2 to 10 are diagrams showing examples of the UI displayed on the display.

FIG. 2 is a diagram showing an example of the UI for a measure against an error.

As shown in FIG. 2, UI 400 includes box 401 indicating the status of a measure for eliminating an error and operation states 402 of devices for production. Box 401 includes the name of a device for production which is an error elimination target, a device ID, an operation status, the last updating time of the status of the measure, information indicating whether a new message is provided, and progress information described in UI 300. Operation states 402 include, for the devices for production, the names of the devices, device IDs, operation statuses, software versions, and installation places. For example, operation states 402 in UI 400 indicate that an error occurs in mounting device A in dotted frame 403. For example, the user has selected dotted frame 403 to be able to transition to UI 410 on which the detail of the error is displayed.

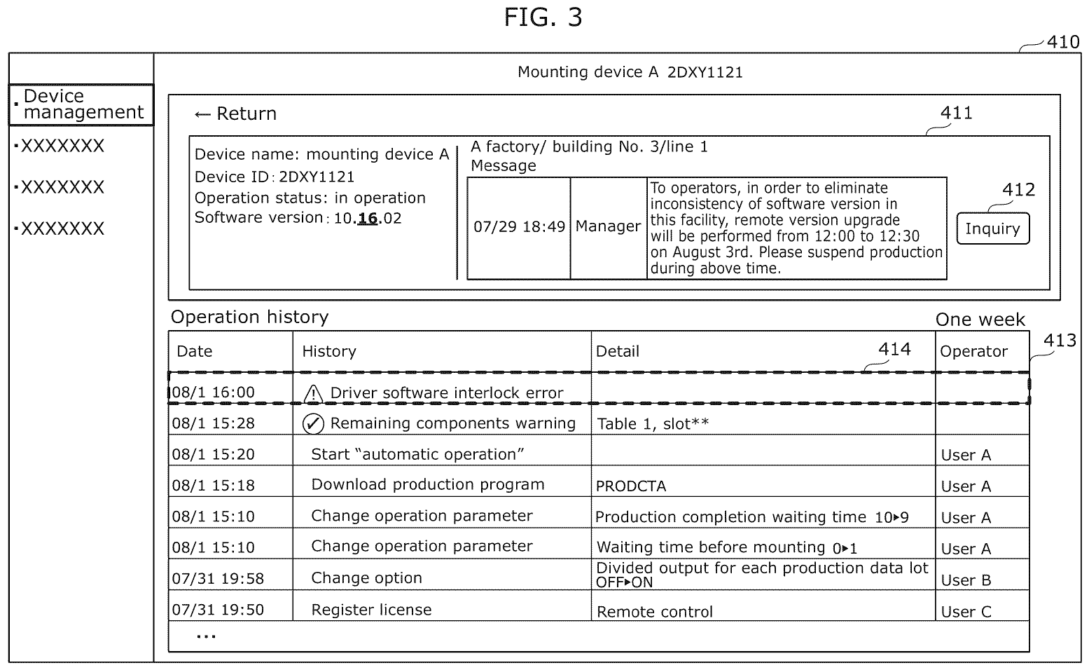

When the selection of dotted frame 403 is performed, as shown in FIG. 3, UI 400 is updated to UI 410. UI 410 includes box 411 and history information 413. UI 411 includes information related to selected mounting device A and a message related to the error occurring in mounting device A. Box 411 includes inquiry button 412 for making an inquiry about the error. When an input to inquiry button 412 is received, UI 410 transitions to UI 420.

History information 413 includes the history of changes of the operation statuses and the history of reception of operations from the user. History information 413 includes a date, a history, a detail, and an operator. The date indicates a date (time of day) on which a change of the operation status was made and a date (time of day) on which an operation is received from the user. The history indicates the detail of the change of the operation status and the type of operation received from the user. The detail includes detailed information of the history. The operator indicates information (for example, a user ID or a user name) for identifying an operator who performed an operation. UI 410 indicates that as in dotted frame 414, an error occurred in mounting device A at 16:00 on 8/1.

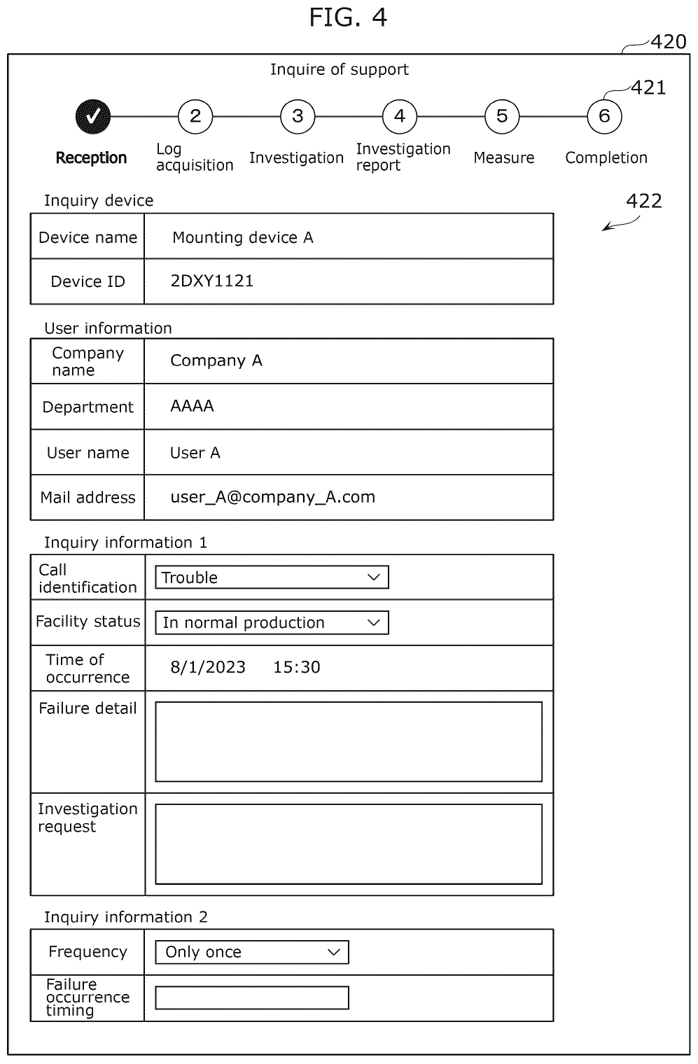

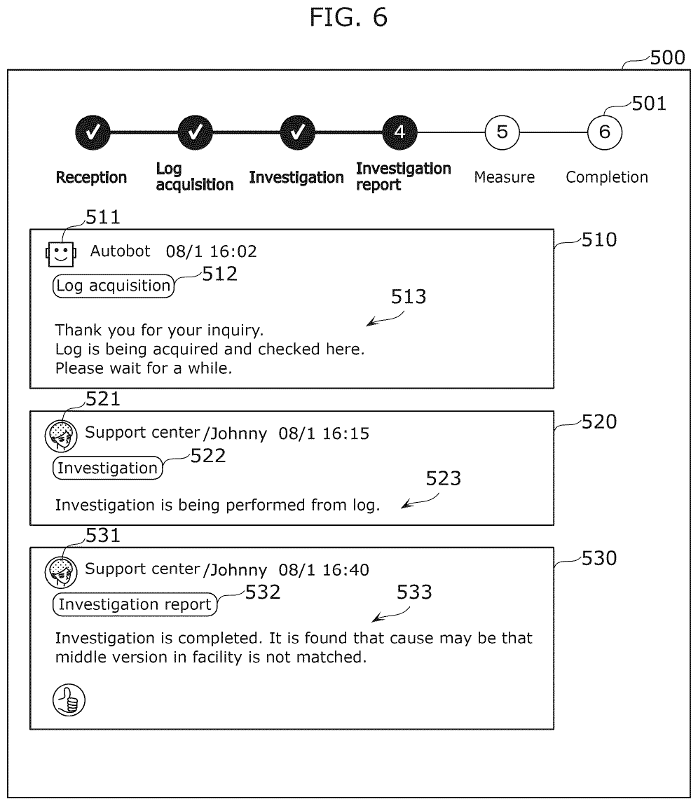

When an input to inquiry button 412 is received, as shown in FIG. 4, UI 410 is updated to UI 420. UI 420 includes progress information 421 and information 422 related to the inquiry. Since progress information 421 is the same as progress information 501 which will be described later with reference to FIG. 6, the description thereof is omitted.

Information 422 related to the inquiry includes an inquiry device, user information, inquiry information 1, and inquiry information 2. The inquiry device includes the name of a device which is an inquiry target and a device ID. The user information includes the name of a company and a department to which the user of the device serving as the inquiry target belongs, a user name, and the email address of the user. Inquiry information 1 includes call identification indicating the type of inquiry, a facility status indicating the operation status of the device, the time of occurrence (time of day of occurrence) of an error which causes the inquiry, the detail of a failure, and an investigation request. A box in the detail of the failure relates to the detail of the error which is grasped by the user. A box in the investigation request relates to a detail which the user wants a support center to investigate. The boxes in the detail of the failure and in the investigation request receive text inputs made by the user. Inquiry information 2 includes a frequency and failure occurrence timing. The frequency indicates the frequency of occurrence of errors, and indicates inputs received from the user. The failure occurrence timing indicates information related to timing at which the error occurred, and indicates text received from the user.

The inquiry device is information which can be identified at the time when an input to inquiry button 412 is received. The user information is information which can be identified even when the user does not input the information as long as the information is previously registered by the user.

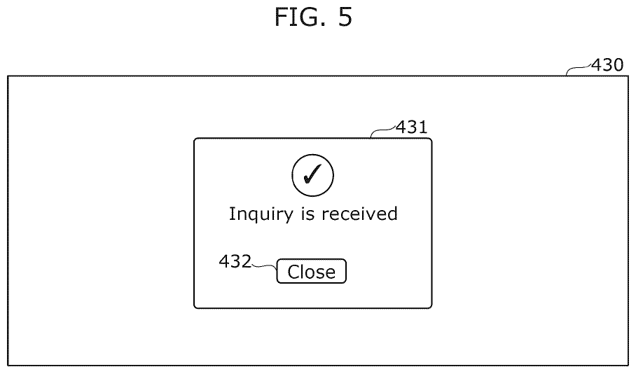

When an input which indicates the determination of the inquiry is received in UI 420, as shown in FIG. 5, UI 420 is updated to UI 430. UI 430 includes reception completion information 431 which indicates that the reception of the inquiry has been completed. Reception completion information 431 may include closing button 432 for closing reception completion information 431 (deleting it from the screen).

When the inquiry is received, and then processing for the inquiry which is performed by server 200 (that is, processing for eliminating the error) is started, as shown in FIG. 6, display 114 displays UI 500.

UI 500 is a UI which is displayed on display 114 after the reception of the inquiry has been completed. UI 500 includes progress information 501 which indicates a procedure including a plurality of steps for eliminating the error and message boxes 510, 520, and 530.

Progress information 501 is an example of the procedure including the plurality of steps to be taken after the error has occurred until a measure for eliminating the error is performed. In the example shown in FIG. 6, the steps indicated by progress information 501 are reception, log acquisition, an investigation, an investigation report, a measure, and completion. The reception includes, for example, the reception of occurrence of the error or the reception of an inquiry about the error from the user. The log acquisition is the acquisition of a log. The investigation is an investigation for identifying the cause of occurrence of the error from the error or the log. The investigation report is a report of the cause of occurrence of the error which is identified as a result of the investigation. The measure is a measure for eliminating the error. The completion indicates the completion of the steps.

In progress information 501, among the steps, the completion of the steps of the reception, the log acquisition, the investigation, and the investigation report is indicated by check marks. In progress information 501, “4” of the investigation report is indicated by a white character in a black background, and thus the current step is the investigation report. As described above, the completed steps are indicated by the check marks, the current step is not completed and indicated by the check mark, and thus a step which is adjacent to the steps indicated by the check marks and is not indicated by the check mark is the current step. In progress information 501, “5” of the measure and “6” of the completion are indicated by black characters in a white background, and thus the steps of the measure and the completion are not completed.

Message boxes 510, 520, and 530 are displayed to correspond to the steps. Each of message boxes 510, 520 and 530 is displayed, for example, when a step preceding the corresponding step has been completed.

Message boxes 510, 520, and 530 include icons 511, 521, and 531, step information 512, step information 522, and step information 532, and messages 513, 523, and 533, respectively. Each of icons 511, 521, and 531 is an example of the generator information indicating the generator of the message included in the same message box as the corresponding icon. Each of step information 512, step information 522, and step information 532 indicates a step corresponding to the message included in the same message box as the corresponding step information. Messages 513, 523, and 533 respectively correspond to one or more steps (a plurality of steps in FIG. 6) from the first step up to the current step among the steps indicated by progress information 501. In the example shown in FIG. 6, the first step is the reception, and the current step is the investigation report.

Message box 510 is displayed when the step of the log acquisition is performed. Icon 511 in message box 510 indicates that message 513 included in message box 510 has been automatically generated by server 200. In other words, icon 511 is an example of the generator information indicating that the generator of message 513 is server 200. Step information 512 indicates a step corresponding to message box 510, and indicates that the step described above is the log acquisition among the steps in progress information 501.

Message box 520 is displayed when the step of the investigation is performed. Icon 521 in message box 520 indicates that message 523 included in message box 520 has been generated according to an input made by the manager (that is, the user of second computer 120). In other words, icon 521 is an example of the generator information indicating that the generator of message 523 is the manager. Step information 522 indicates a step corresponding to message box 520, and indicates that the step described above is the investigation among the steps in progress information 501.

Message box 530 is displayed when the step of the investigation report is performed. Icon 531 in message box 530 indicates that message 533 included in message box 530 has been generated according to an input made by the manager (that is, the user of second computer 120). In other words, icon 531 is an example of the generator information indicating that the generator of message 533 is the manager. Step information 532 indicates a step corresponding to message box 530, and indicates that the step described above is the investigation report among the steps in progress information 501.

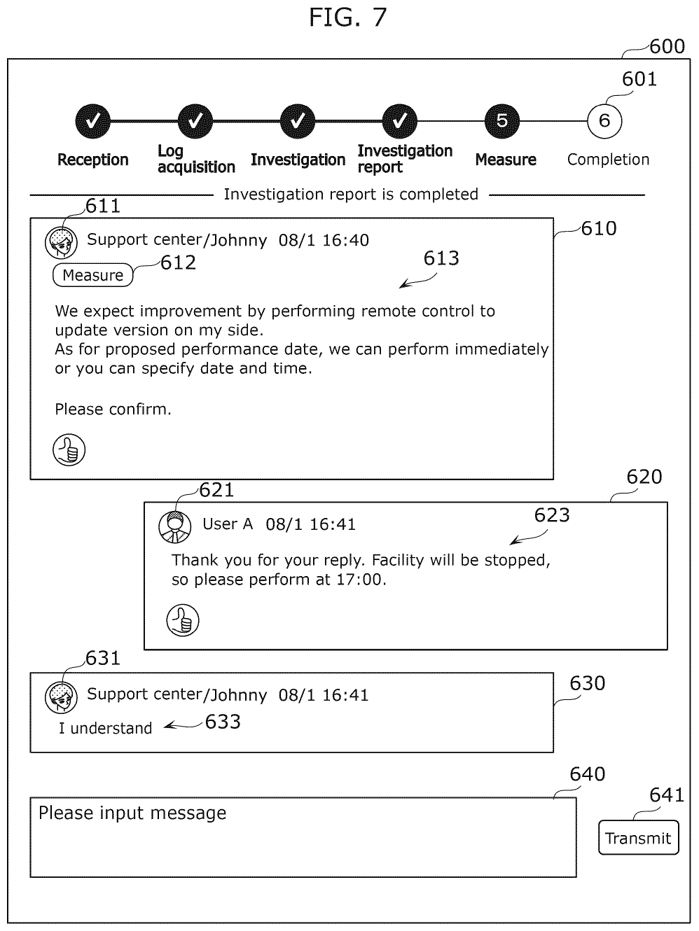

When the procedure proceeds one step from the state of UI 500, for example, as shown in FIG. 7, display 114 displays UI 600.

UI 600 includes progress information 601, message boxes 610, 620, and 630, text box 640, and transmission button 641. Progress information 601 is the same as progress information 501 except that the investigation report has been completed, and the current step is the measure.

Message box 610 is displayed to correspond to one of the steps. Message box 610 is displayed, for example, when a step preceding the corresponding step has been completed.

Message boxes 610, 620, and 630 include icons 611, 621, and 631 and messages 613, 623, and 633, respectively.

Message box 610 is displayed when the corresponding step is performed. Icon 611 in message box 610 indicates that message 613 included in message box 610 has been generated according to an input made by the manager (that is, the user of second computer 120). In other words, icon 611 is an example of the generator information indicating that the generator of message 613 is the manager. Step information 612 indicates a step corresponding to message box 610, and indicates that the step described above is the measure among the steps in progress information 601.

Message box 620 includes icon 621 indicating the user and message 623 input by the user. Icon 621 in message box 620 indicates that message 623 included in message box 620 has been generated according to an input made by the user (that is, the user of first computer 110). In other words, icon 621 is an example of the generator information indicating that the generator of message 623 is the user of production management system 1.

Message box 630 includes icon 631 indicating the manager and message 633 input by the manager. Icon 631 in message box 630 indicates that message 633 included in message box 630 has been generated according to an input made by the manager (that is, the user of second computer 120). In other words, icon 631 is an example of the generator information indicating that the generator of message 633 is the manager.

Text box 640 receives an input of a further message which is displayed on UI 600 by the user of first computer 110. When an input to transmission button 641 is received, text which is input into text box 640 is received as the message. In this way, a new message box is added to UI 600.

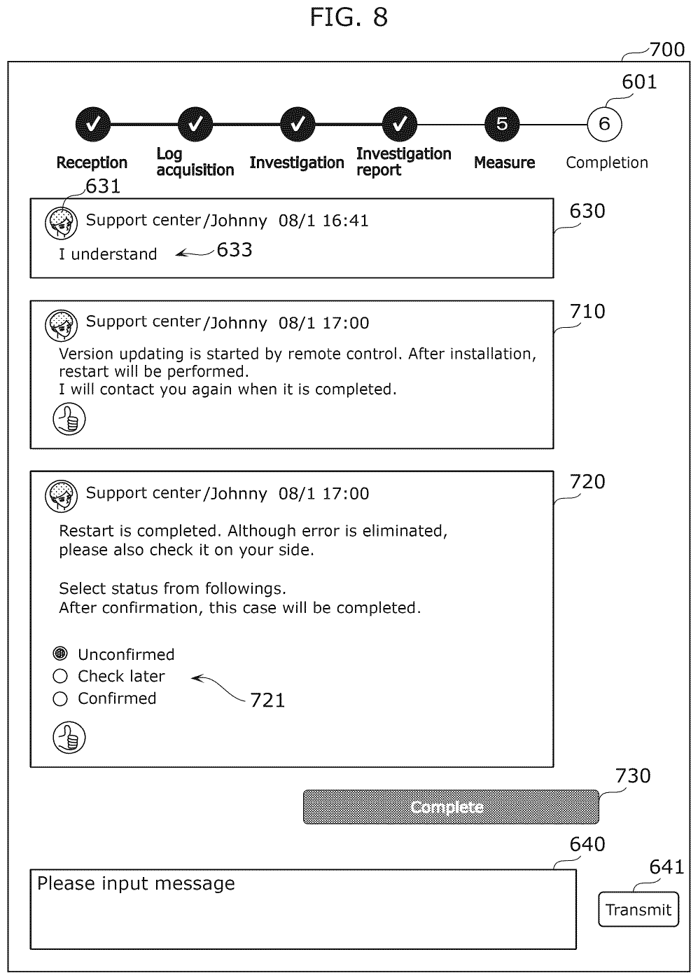

When messages are further exchanged from UI 600, for example, as shown in FIG. 8, UI 600 is updated to UI 700.

UI 700 includes progress information 601, message boxes 630, 710, and 720, completion button 730, text box 640, and transmission button 641. UI 700 is the same as UI 600 in progress information 601, message box 630, text box 640, and transmission button 641. In UI 700, message boxes 710 and 720 are newly added. In UI 700, message boxes 610 and 620 included in UI 600 can be displayed by scrolling.

Message box 720 includes radio button 721 which receives the selection of a status performed by the user. For example, radio button 721 in message box 720 prompts the user to input a confirmation result as to whether the restart of mounting device A has been completed. Radio button 721 receives an input for identifying one of three statues of “unconfirmed”, “check later”, and “confirmed”. In UI 700, completion button 730 is displayed in a grayed-out state, and this indicates that completion button 730 is in a state where completion button 730 is not capable of receiving an input made by the user. Even when an input to completion button 730 is made on UI 700, the input is not received.

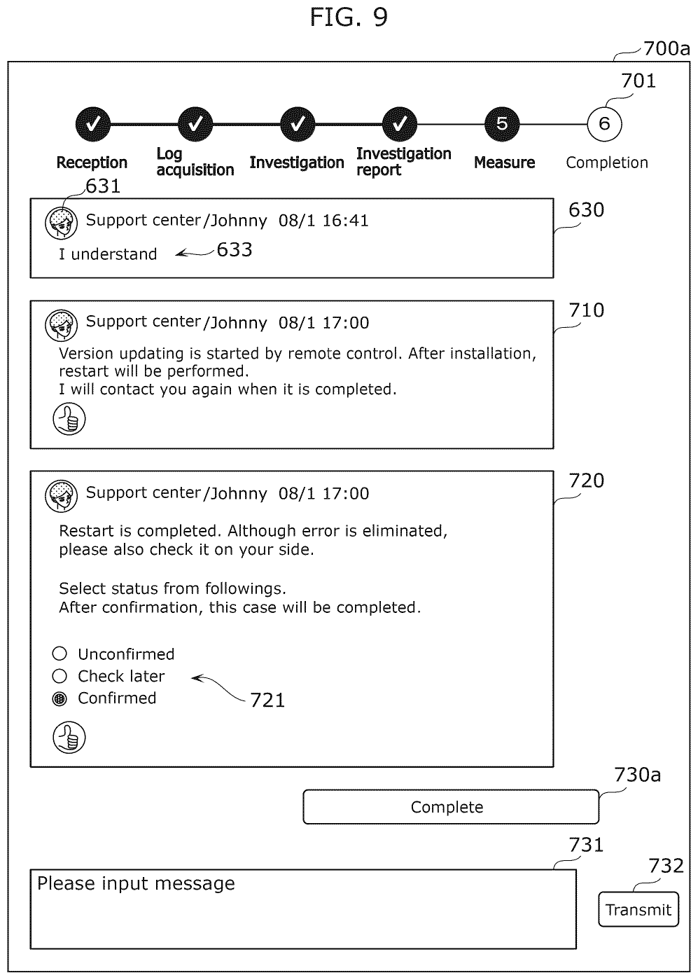

When the “confirmed” is selected in radio button 721, display 114 displays UI 700a as shown in FIG. 9. In UI 700a, completion button 730 which was displayed in the grayed-out state is changed to completion button 730a in a display form capable of receiving an input. In this way, an input to completion button 730a is received, inquiry processing for eliminating the error has been completed. UI 700a includes progress information 701, message boxes 630, 710, and 720, completion button 730a, text box 731, and transmission button 732. Text box 731 and transmission button 732 correspond to text box 640 and transmission button 641, respectively.

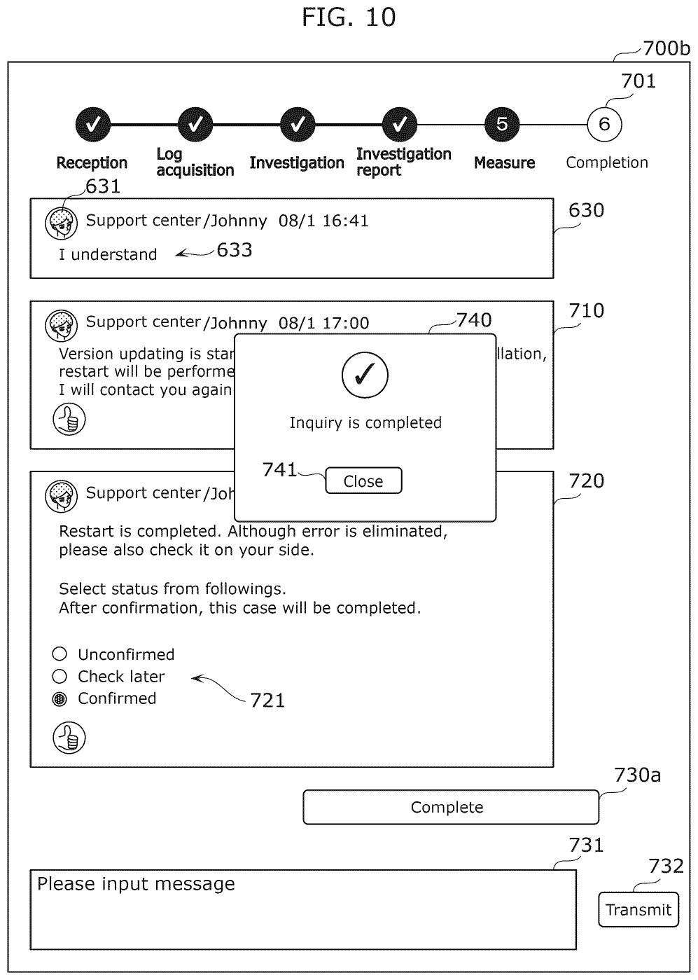

Then, display 114 displays UI 700b as shown in FIG. 10. UI 700b displays inquiry completion information 740 which indicates that the inquiry processing has been completed. UI 700b may include button 741 for closing inquiry completion information 740 (deleting it from the screen).

As described above, in UI 500, UI 600, UI 700, and UI 700a, messages can be exchanged between the user, server 200, and the manager. In other words, in UI 500, UI 600, UI 700, and UI 700a, a chat function is provided between the user, server 200, and the manager.

Each of UI 500, UI 600, UI 700, and UI 700a may have a size larger than the size of the display region of display 114 (display) which is displayed. In this case, each of UI 500, UI 600, UI 700, and UI 700a is not displayed at once in the display region of display 114, and a partial region of each of the UIs corresponding to the size of the display region of display 114 is displayed. First computer 110 may receive an input from the user such that the partial region is changed. For example, first computer 110 may receive an input of scrolling the UI such that the partial region displayed on display 114 is changed. As described above, each of UI 500, UI 600, UI 700, and UI 700a may have a part which extends beyond display 114 and is not displaced on display 114, or may form one screen including a part which is not displayed.

### 3. Operation

Inquiry measure processing for eliminating an error in system 100 will then be described.

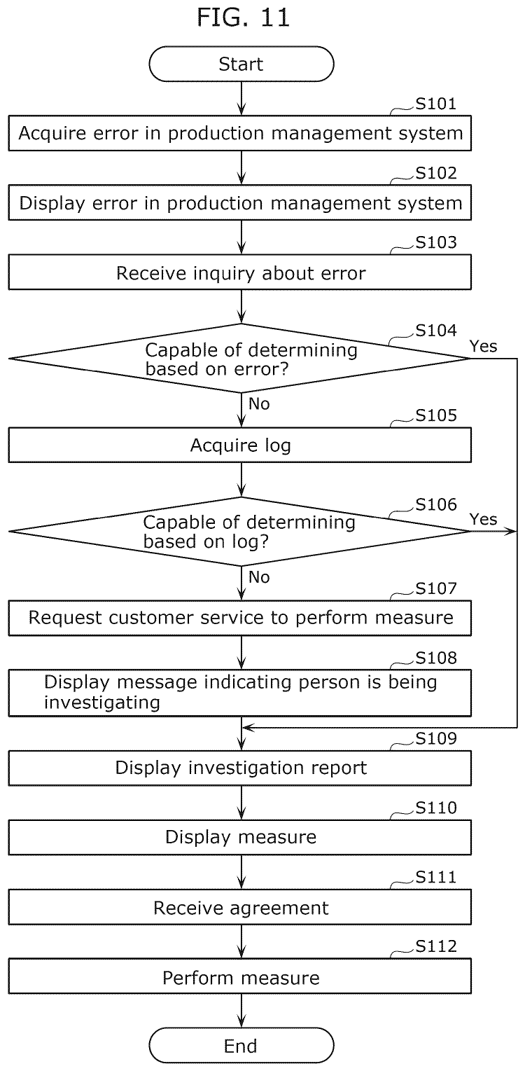

FIG. 11 is a flowchart showing an example of the inquiry measure processing for eliminating an error performed by the server.

Server 200 acquires error information indicating an error in production management system 1 (S101).

Then, server 200 displays the error in the production management system on display 114 of first computer 110 (S102).

Then, server 200 receives an inquiry about the error from first computer 110 (S103).

Then, server 200 determines whether server 200 is capable of determining a measure for eliminating the error based on the error (S104).

When server 200 determines that server 200 is capable of determining the measure for eliminating the error based on the error (yes in S104), server 200 performs step S109. On the other hand, when server 200 determines that server 200 is not capable of determining the measure for eliminating the error based on the error (no in S104), server 200 performs step S105.

Server 200 acquires a log in step S105 (S105). Server 200 may acquire the log which is previously stored in storage 203 or may acquire the log from production management system 1 via network 30. Server 200 determines whether the log is stored in storage 203, and when the log is stored in storage 203, server 200 may acquire the log from storage 203, and when the log is not stored in storage 203, server 200 may acquire the log from production management system 1 via network 30. Here, the acquired log is a log which is generated in production management system 1 during a period after the time of day when a determination of no is made in step S104 until a predetermined time elapses. For example, the acquired log is a log which is generated during the latest period in a period after the start of the operation of production management system 1 until the present time. The latest period is later than other periods in the period after the start of the operation of production management system 1 until the present time.

Then, server 200 determines whether server 200 is capable of determining the measure for eliminating the error based on the log (S106).

When server 200 determines that server 200 is capable of determining the measure for eliminating the error based on the log (yes in S106), server 200 performs step S109. On the other hand, when server 200 determines that server 200 is not capable of determining the measure for eliminating the error based on the log (no in S106), server 200 performs step S107.

In step S107, server 200 requests the customer service to perform a measure (S107). Specifically, since server 200 is not capable of automatically determining the measure for eliminating the error, server 200 transmits, to second computer 120, a request to perform the measure for eliminating the error. Second computer 120 receives the request to perform the measure for eliminating the error, and thereby can display, on display 124, the occurrence of the error which cannot be automatically eliminated by server 200. In this way, the manager (the operator of the customer service) who is the user of second computer 120 can start the measure for eliminating the error based on the request. For example, the manager transmits, from second computer 120 to server 200, a message indicating that an investigation is being performed.

Then, server 200 displays, on display 114 of first computer 110, the message indicating that the person (that is, the operator of the customer service) is investigating the error (S108).

Then, server 200 displays an investigation report on display 114 of first computer 110 (S109). When server 200 is capable of automatically determining the measure for eliminating the error, the investigation report is generated by server 200. When server 200 is not capable of automatically determining the measure for eliminating the error, the person (that is, the operator of the customer service) makes an input to second computer 120, and thus the investigation report is generated by second computer 120.

Then, server 200 displays the measure based on the investigation report on display 114 of first computer 110 (S110).

Then, server 200 inquires of first computer 110 whether the user allows server 200 to perform the measure, and receives an input indicating agreement from the user via first computer 110 (S111).

Then, server 200 performs the measure agreed to by the user on production management system 1 (S112). For example, when an error caused by an old version of software occurs in mounting device A of production management system 1, server 200 performs a measure for causing mounting device A to update the version of software to a new version. In this way, the error occurring in mounting device A can be eliminated.

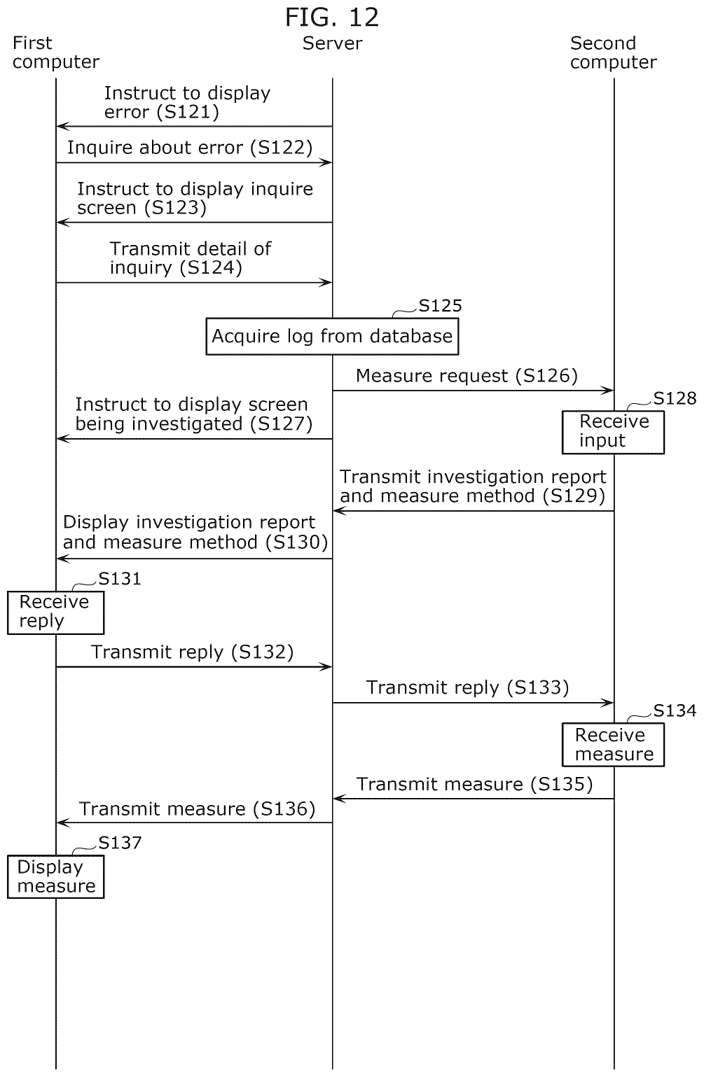

FIG. 12 is a sequence diagram showing an example of the inquiry measure processing for eliminating an error in the system.

Server 200 transmits, to first computer 110, an instruction to display an error which occurs in production management system 1 (S121).

In this way, when first computer 110 displays UI 400 as described in FIG. 2, receives an input related to the error from the user, and receives an input to inquiry button 412 on UI 410, first computer 110 transmits a request for an inquiry screen to server 200 (S122).

Server 200 transmits an instruction to display the inquiry screen to first computer 110 based on the request for the inquiry screen received from first computer 110 (S123).

First computer 110 displays UI 420 showing the inquiry screen in FIG. 4, and transmits, based on an input to UI 420, the detail of the inquiry (information related to the inquiry) to server 200 (S124).

Server 200 acquires a log from the database in storage 203 (S125). When the log is not stored in storage 203, server 200 acquires the log from production management system 1.

When server 200 is not capable of determining a measure for eliminating the error, server 200 transmits a measure request to second computer 120 (S126). When server 200 is capable of determining a measure for eliminating the error, server 200 performs processing corresponding to the measure.

Server 200 transmits, to first computer 110, an instruction to display an investigating screen indicating that the error is being investigated (S127).

When second computer 120 receives the measure request, second computer 120 receives an input from the manager (S128). For example, second computer 120 receives, from the manager, an input of a message related to the measure for eliminating the error included in the measure request. The message includes the investigation report and a measure method. Second computer 120 may separately transmit a message of the investigation report and a message of the measure method to server 200.

Second computer 120 transmits the message of the investigation report and the measure method to server 200 (S129).

Server 200 receives the message of the investigation report and the measure method, and displays the message on first computer 110 (S130).

First computer 110 displays a message indicating whether the user allows first computer 110 to perform the measure corresponding to the message, and receives a reply to the message from the user (S131).

First computer 110 transmits the reply received from the user to server 200 (S132).

Server 200 receives the reply received from the user, and transmits the reply to second computer 120 (S133).

Second computer 120 receives the measure according to the reply (S134), and transmits the received measure to server 200 (S135).

Server 200 receives the measure, and transmits the measure to first computer 110 (S136).

First computer 110 displays the received measure (S137).

### 4. Effects and Like

Server 200 (information processing system) according to the present embodiment is connected to production management system 1 and first computer 110 via network 30 (the Internet). Server 200 acquires information related to an error in production management system 1. Server 200 displays, on display 114 of first computer 110, a procedure including a plurality of steps to be taken after the error has occurred until a measure for eliminating the error is performed and a message corresponding to each of one or more steps from a first step up to a current step among the plurality of steps.

In this way, the procedure including the plurality of steps to be taken after the error has occurred until the measure for eliminating the error is performed and the message corresponding to each of the steps are displayed, and thus it is possible to present, to the user, the progress for eliminating the error and the message corresponding to the progress. Hence, the user can easily recognize the message corresponding to the current step in the progress, and thereby can easily inquire about the progress.

Server 200 according to the present embodiment displays, on display 114, the message together with step information indicating the step corresponding to the message among the plurality of steps.

Hence, the user can easily recognize the message corresponding to each of the steps in the progress.

In server 200 according to the present embodiment, the message is generated by server 200. Server 200 displays, on display 114, the message together with generator information indicating the generator of the message.

Hence, the user can easily recognize the generator of the message.

Server 200 according to the present embodiment further acquires a log related to at least one of the operation or the state of production management system 1. Server 200 determines whether server 200 is capable of determining, based on the log, the measure for eliminating the error. Server 200 generates a first message including the detail of the measure when determining that server 200 is capable of determining the measure. Server 200 displays, on display 114, the first message together with the generator information indicating server 200.

Hence, the user can easily recognize that the first message has been automatically generated by server 200 (information processing system).

Server 200 according to the present embodiment determines whether server 200 is capable of determining, based on the error, the measure for eliminating the error. Server 200 generates a first message including the detail of the measure when determining that server 200 is capable of determining the measure based on the error. Server 200 displays, on display 114, the first message together with the generator information indicating server 200.

Hence, the user can easily recognize that the first message has been automatically generated by server 200 (information processing system).

Server 200 according to the present embodiment further acquires a log related to at least one of the operation or the state of production management system 1 when determining that server 200 is not capable of determining the measure for eliminating the error. Server 200 determines whether server 200 is capable of determining, based on the log, the measure for eliminating the error. Server 200 generates a first message including the detail of the measure when determining that server 200 is capable of determining the measure. Server 200 displays, on display 114, the first message together with the generator information indicating server 200.

Hence, the user can easily recognize that the first message has been automatically generated by server 200 (information processing system).

Server 200 according to the present embodiment determines whether a database included in server 200 includes the log. When server 200 determines that the database does not include the log, server 200 further acquires the log from production management system 1 via the Internet.

Hence, when the log is acquired from the database, server 200 (information processing system) can perform processing using the log previously acquired from production management system 1, with the result that it is possible to reduce the time until the processing is started. On the other hand, when the log cannot be acquired from the database, server 200 can reduce a storage capacity for storing the log.

Server 200 according to the present embodiment transmits, via network 30, a request for input of a message related to the measure to second computer 120 when determining that server 200 is not capable of determining the measure. Server 200 displays, on display 114, a third message transmitted from second computer 120 in response to the request together with the generator information indicating second computer 120.

Hence, the user can easily recognize that the second message has been input by the operator of the second computer.

When one step among the plurality of steps has been completed, server 200 according to the present embodiment displays, on display 114, together with a step subsequent to the one step, a message corresponding to the step subsequent thereto.

Hence, when the one step has been completed, the user can recognize the message for the subsequent step.

When one step among the plurality of steps has been completed, server 200 according to the present embodiment displays, on display 114, completion information indicating that the one step has been completed.

Hence, the user can recognize that the one step has been completed.

In server 200 according to the present embodiment, the plurality of steps include acquiring a log related to at least one of the operation or the state of the production management system. When the acquiring of the log has been completed, server 200 displays, on display 114, completion of a transition to a step subsequent to the acquiring of the log.

Hence, the user can recognize the completion of the transition to the step subsequent to the acquiring of the log.

### 5. Variation

(1) Server 200 according to the present embodiment may include the function of second computer 120. In other words, server 200 may include the function of receiving an input made by the manager and the function of displaying the UI for the manager.

### 6. Others

In the embodiment described above, constituent elements may be formed by dedicated hardware or may be realized by executing software programs suitable for the constituent elements. A program executor such as a CPU or a processor may read and execute software programs recorded in a recording medium such as a hard disk or a semiconductor memory such that the constituent elements are realized. Here, software for realizing the production management device, the production management system, and the like in the embodiment is programs which cause a computer to execute the steps included in the flowchart shown in the figure

The following cases are also included in the present disclosure.

(1) Specifically, the devices described above are a computer system which includes a microprocessor, a ROM, a RAM, a hard disk unit, a display unit, a keyboard, a mouse and the like. In the RAM or the hard disk unit, computer programs are stored. The microprocessor is operated according to the computer programs, and thus the devices described above achieve the functions thereof. Here, the computer programs are formed by combining a plurality of command codes for indicating instructions to the computer in order to achieve predetermined functions.

(2) A part or all of constituent elements of the devices described above may be formed with one system large scale integration (LSI) circuit. The system LSI circuit is an ultra-multifunctional LSI circuit manufactured by integrating a plurality of constituent units on one chip, and is specifically a computer system which includes a microprocessor, a ROM, a RAM, and the like. In the RAM, computer programs are stored. The microprocessor is operated according to the computer programs, and thus the system LSI circuit achieves the functions thereof.

(3) A part or all of constituent elements of the devices described above may be formed with an IC card or a single module which is removal with respect to the devices. The IC card or the module is a computer system which includes a microprocessor, a ROM, a RAM and the like. The IC card or the module may include the ultra-multifunctional LSI circuit. The microprocessor is operated according to computer programs, and thus the IC card or the module achieves the functions thereof. The IC card or the module may be tamper resistant.

(4) The present disclosure may be the methods described above. The present disclosure may be computer programs which realize these methods with a computer or may be digital signals of the computer programs described above.

The present disclosure may be computer-readable recording media, such as a flexible disc, a hard disk, a CD-ROM, an MO, a DVD, a DVD-ROM, a DVD-RAM, a Blu-ray (registered trademark) disc (BD), and a semiconductor memory, in which the computer programs or the digital signals are recorded. The present disclosure may be the digital signals recorded in these recording media.

The present disclosure may be a system in which the computer programs or the digital signals are transmitted via a telecommunication line, a wireless or wired communication line, a network such as the Internet, data broadcasting, or the like.

The present disclosure may be a computer system which includes a microprocessor and a memory, the memory may store the computer programs, and the microprocessor may be operated according to the computer programs.

The programs or the digital signals may be recorded in the recording medium and transferred or may be transferred via the network or the like such that another independent computer system uses the programs or the digital signals.

(5) The embodiment and the variation may be combined.

Although only the exemplary embodiment of the present disclosure has been described in detail above, those skilled in the art will readily appreciate that many modifications are possible in the exemplary embodiment without materially departing from the novel teachings and advantages of the present disclosure. Accordingly, all such modifications are intended to be included within the scope of the present disclosure.

### INDUSTRIAL APPLICABILITY

The present disclosure is useful as an information processing system or the like in which a user can easily inquire about progress.

1. An information processing system connected to a production management system and a first computer via Internet, the information processing system comprising:
an acquirer that acquires information related to an error in the production management system; and
a controller that displays, on a display of the first computer:
a procedure including a plurality of steps to be taken after the error has occurred until a measure for eliminating the error is performed; and
a message corresponding to each of one or more steps from a first step up to a current step among the plurality of steps.

2. The information processing system according to claim 1,
wherein the controller displays, on the display, the message together with step information indicating a step corresponding to the message among the plurality of steps.

3. The information processing system according to claim 2,
wherein the message is generated by the information processing system, and
the controller displays, on the display, the message together with generator information indicating a generator of the message.

4. The information processing system according to claim 3,
wherein the acquirer further acquires a log related to at least one of an operation or a state of the production management system, and
the controller:
determines whether the controller is capable of determining, based on the log, the measure for eliminating the error;
generates a first message including a detail of the measure when determining that the controller is capable of determining the measure; and
displays, on the display, the first message together with the generator information indicating the information processing system.

5. The information processing system according to claim 3,
wherein the controller:
determines whether the controller is capable of determining, based on the error, the measure for eliminating the error;
generates a second message including a detail of the measure when determining that the controller is capable of determining, based on the error, the measure; and
displays, on the display, the second message together with the generator information indicating the information processing system.

6. The information processing system according to claim 5,
wherein the acquirer further acquires a log related to at least one of an operation or a state of the production management system when the controller determines that the controller is not capable of determining the measure for eliminating the error, and
the controller:
determines whether the controller is capable of determining, based on the log, the measure for eliminating the error;
generates a first message including a detail of the measure when determining that the controller is capable of determining, based on the log, the measure; and
displays, on the display, the first message together with the generator information indicating the information processing system.

7. The information processing system according to claim 4,
wherein the acquirer acquires the log from a database included in the information processing system.

8. The information processing system according to claim 4,
wherein the controller determines whether a database included in the information processing system includes the log, and
when the controller determines that the database does not include the log, the acquirer acquires the log from the production management system via the Internet.

9. The information processing system according to claim 4,
wherein the acquirer acquires the log from the production management system via the Internet.

10. The information processing system according to claim 4,
wherein the controller:
transmits, via the Internet, a request for input of a message related to the measure to a second computer when determining that the controller is not capable of determining the measure; and
displays, on the display, a third message transmitted from the second computer in response to the request together with the generator information indicating the second computer.

11. The information processing system according to claim 1,
wherein when one step among the plurality of steps has been completed, the controller displays, on the display, together with a step subsequent to the one step, a message corresponding to the step subsequent to the one step.

12. The information processing system according to claim 11,
wherein when one step among the plurality of steps has been completed, the controller displays, on the display, completion information indicating that the one step has been completed.

13. The information processing system according to claim 12,
wherein the plurality of steps include acquiring a log related to at least one of an operation or a state of the production management system, and
when the acquiring of the log has been completed, the controller displays, on the display, completion of a transition to a step subsequent to the acquiring of the log.

14. The information processing system according to claim 1,
wherein the production management system includes:
a mounting line that includes a mounting device and a printing device; and
a production support device that supports production on the mounting line.

15. An information processing method to be performed by an information processing system connected to a production management system and a first computer via Internet, the information processing method comprising:
acquiring information related to an error in the production management system; and
displaying, on a display of the first computer,
a procedure including a plurality of steps to be taken after the error has occurred until a measure for eliminating the error is performed and
a message corresponding to each of one or more steps up to a current step among the plurality of steps.

16. A display method to be performed by a computer connected to a production management system and an information processing system via Internet, the display method comprising:
acquiring, by the computer, display information to be displayed on a display of the computer, from the information processing system; and
displaying, on the display of the computer, an on-screen display based on the display information,
wherein the on-screen display includes:
a procedure including a plurality of steps to be taken after an error has occurred until a measure for eliminating the error is performed; and
a message corresponding to each of one or more steps up to a current step among the plurality of steps.
